(19) United States
(12) Patent Application Publication
(10) Pub. No.: US 2005/0120625 A1
(43) Pub. Date: Jun. 9, 2005

(54) Self-contained planter system

(76) Inventor: Jennifer Appel, Houston, TX (US)

Correspondence Address: LOCKE LIDDELL & SAPP LLP, 600 TRAVIS, 3400 CHASE TOWER, HOUSTON, TX, 77002-3095, US

(21) Appl. No.: 10/727,851

(22) Filed: Dec. 4, 2003

(51) Int. Cl. A01G 9/02

(52) U.S. Cl. 47/65.6

(57) ABSTRACT

The present invention includes an improved planter system that can be located in a variety of locations largely independent of available light and water sources. In at least one embodiment, the invention provides a self-contained planter system, having a water retaining box, an elevated first soil retaining box disposed above the water retaining box; and a drain portal in the soil retaining box adapted to drain into the water retaining box. A pump provides water recirculation from the water retaining box to the soil retaining box using water that drains from the soil retaining box into the water retaining box. A light mounted above the soil retaining box provides light independent of ambient conditions. The invention can also include a stacked array of soil containing boxes where excess water in a higher soil retaining box drains onto a lower soil retaining box and then to the water retaining box.

### FIELD OF THE INVENTION

The invention relates to planters. More specifically, the invention relates to planter systems having an integrated source of water.

### BACKGROUND OF THE INVENTION

Planter systems are as old as dirt. As society became more settled and inhabitants of buildings and homes realized the benefits of bringing the plants inside, planter systems moved inside. The challenge became providing a sufficient amount of light and water to allow the plants to thrive at least as well as they could outside.

Typically, the plants are placed adjacent a lighted window and hand watered. Hand watering entails bringing the plant to a faucet for water if it is small or bringing a water container to the plant if it is large. In many situations, neither the light is conveniently located to the plant nor is watering conducted on a regular basis. In either case, the location and health of the plant is limited.

These limitations are especially problematic to landscape designers and architects planning lobbies, walkways, and other accessible areas. The building design or the aesthetics or both are sometimes compromised depending on the available light and convenience of watering sources adjacent a large array of plants.

Thus, there remains a need for an improved planter system that can be flexibly located independent of available light sources and available water sources.

### SUMMARY OF THEE INVENTION

The present invention includes an improved planter system that can be located in a variety of locations largely independent of available light and water sources. In at least one embodiment, the invention provides a self-contained planter system, having a water retaining box, an elevated first soil retaining box disposed above the water retaining box; and a drain portal in the soil retaining box adapted to drain into the water retaining box. A pump provides water recirculation from the water retaining box to the soil retaining box using water that drains from the soil retaining box into the water retaining box. A light mounted above the soil retaining box provides light independent of ambient conditions. The invention can also include a stacked array of soil containing boxes where excess water in a higher soil retaining box drains onto a lower soil retaining box and then to the water retaining box.

In one embodiment, the invention provides a self-contained planter system, comprising a water retaining box; an elevated first soil retaining box disposed above at least a portion of the water retaining box; and a drain portal disposed in a lower portion of the soil retaining box and above at least the portion of the water retaining box, and adapted to drain into the water retaining box.

In another embodiment, the invention also provides a self-contained planter system, comprising: a water retaining box; an elevated first soil retaining box disposed at least partially above the water retaining box, and a drain portal disposed in a lower portion of the first soil retaining box and above the water retaining box; an elevated second soil retaining box disposed at least partially above the first soil retaining box and a drain portal disposed in a lower portion of the second soil retaining box and above the first soil retaining box; a water line coupled to at least the second soil retaining box; a pump coupled to the water retaining box to pump water at least to the second soil retaining box through the water line; and a light mounted above the first soil retaining box and below the second elevated soil retaining box.

### BRIEF DESCRIPTION OF THE DRAWINGS

A more particular description of the invention, briefly summarized above, can be realized by reference to the embodiments thereof that are illustrated in the appended drawings and described herein. However, it is to be noted that the appended drawings illustrate only some embodiments of the invention. Therefore, the drawings are not to be considered limiting of its scope, for the invention may admit to other equally effective embodiments.

FIG. 1 is a cross-sectional schematic side view of one embodiment of a self-contained planter system.

FIG. 2 is a cross-sectional schematic side view of the self-contained planter system of FIG. 1.

FIG. 3 is a schematic side view of the self-contained planter system of FIG. 1.

FIG. 4 is a front schematic view of the self-contained planter system of FIG. 1.

### DETAILED DESCRIPTION OF THE INVENTION

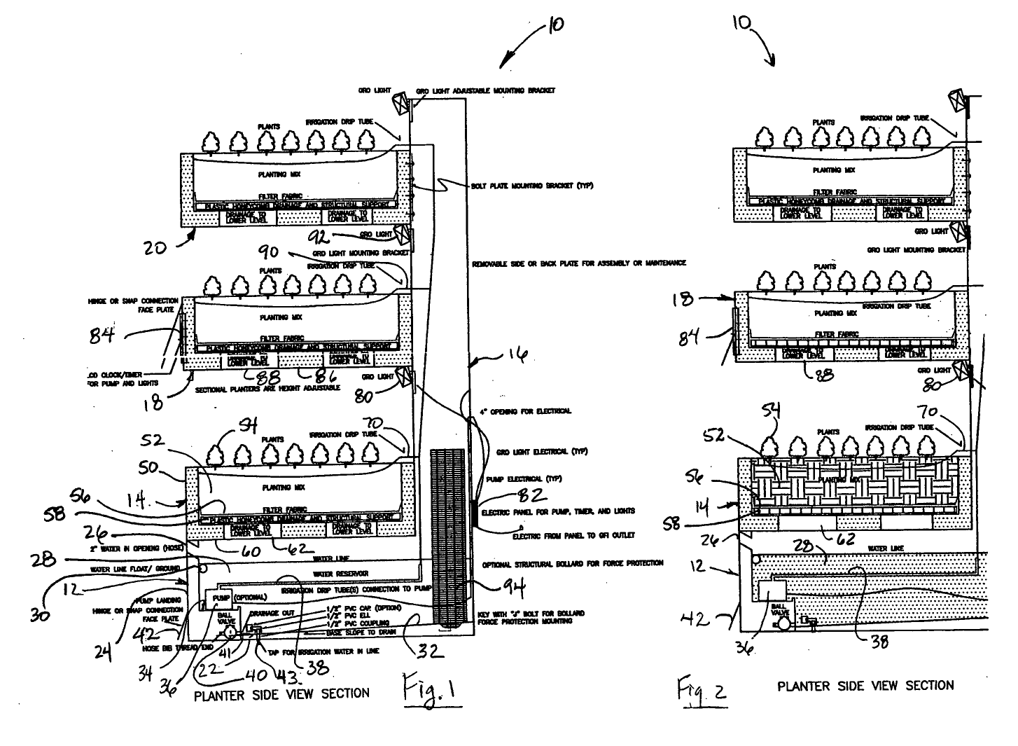

FIG. 1 is a cross-sectional schematic side view of one embodiment of a self-contained planter system. FIG. 2 is a cross-sectional schematic side view of the self-contained planter system of FIG. 1. Similar elements are similarly labeled and the figures will be described together. A self-contained planter system 10 includes at least one water retaining box 12 and at least one soil retaining box, such as a first soil retaining box 14. The system can be relocated in some embodiments to locations that would otherwise be adverse to a plant's growth. The self-contained planter system overcomes the heretofore location barrier by providing a water recycling system and in some embodiments a light to assist in the plant's growth. Some embodiments include a stacked array of other soil retaining boxes, such as a second solar retaining box 18 that is higher than the first soil retaining box 14. Further, a third soil retaining box 20 may be included in the system that generally would be higher than the second soil retaining box 18. A columnar support 16 assists in supporting the various boxes. Further, the various boxes can be height-adjustable for a given location, a particular plant, or other preferences.

As an example of a water retaining box, the water retaining box 12 contains a bottom 22 and sides 24 that retain a quantity of water 28 therein. The term “water” as used herein includes pure water or mixtures of water with other fluids. A water fill opening 26 is provided in the side 24 of the water retaining box 12 to provide make-up water to the system. An optional float control 30 can be provided in the system to control the amount of water 28 in the water retaining box 12. In at least one embodiment, the bottom 22 can include a sloped surface 32 that moves the water toward one portion of the water retaining box 12.

Further, the water retaining box can include a pump landing 34. A pump 36 is disposed on the pump landing 34 to pump the water 28 to other portions of the planter system. In at least one embodiment, the pump 36 can pump the water through a water line 38 that is coupled to one or more of the soil retaining boxes 14, 18, 20 through various branch water lines. Such branch water lines include, for example, water line 70, which can provide water to the first soil retaining box 14, and water line 90 which can provide water to the second soil retaining box 18. The term “coupled,” “coupling,” and like terms are used broadly herein and can include any method or device for securing, binding, bonding, fastening, attaching, joining, inserting therein, forming thereon or therein, communicating, or otherwise associating, for example, mechanically, fluidicly, magnetically, electrically, chemically, directly or indirectly with intermediate elements, one or more pieces of members together and can further include integrally forming one functional member with another.

In at least one embodiment, a conveniently located valve 40 is provided in the water retaining box to assist in flushing out or emptying water from the water retaining box 12. The valve 40, such as a ball valve, is coupled to a drain 41 that is sealingly coupled to the water retaining box to allow water to drain therethrough. Further, the valve outlet can include a threadable connection, such as a hose bib to connect to a hose to assist in draining. The valve, hose bib, and other equipment can be housed in an enclosure 42, which can be attractively concealed with an access plate. An auxiliary outlet 43 can also be included in the water retaining box 12. The auxiliary outlet can be used to provide water for other resources.

The first soil retaining box 14 is disposed at least partially above the water retaining box 12. The first soil retaining box 14 contains soil 52 for growing one or more plants 54. The term “soil” as used herein includes any growing media that will support plant life. The soil retaining box 14 can include a soil filter 56 disposed in lower portions of the soil retaining box 14. A soil filter 56 assists in retaining soil in the soil retaining box 14 while allowing water to drain therethrough. The soil retaining box 14 can also include a support 58 disposed in the lower portions of the soil retaining box 14. The support 58 provides support for the soil filter 56 and also allows water drainage2.

Further, the soil retaining box 14 can include a drain portal 62 disposed in the lower portion of the box. Generally, the drain portal 62 is disposed below the support 58 and fluidicly coupled thereto, so that water draining through the filter 56 and the support 58 can drain through the portal 62. The drain portal 62 is generally formed in the bottom 60 of the soil retaining box 14, but can be formed in other portions of the box. Advantageously, the drain portal 62 is generally aligned above a box underneath it, such as the water retaining box 12. The drain portal can be any size, as may architecturally or structurally be appropriate. In some embodiments, the drain portal 62 can include multiple outlets, such that the function of the soil filter 56 and/or the support 58 can be subsumed with the drain portal.

A water line 70 can be disposed in some portion of the soil retaining box 14. In some embodiments, the water line 70 may be subsurface to the soil 52. A light 80 can be disposed above the soil retaining box 14. The light 80 can be of any appropriate size and intensity as may assist in plant growth. In some embodiments, the light 80 can be a grow light that replicates the light spectrum of sunlight.

A power panel 82 can advantageously provide a junction for the various electrical devices included in the self-contained planter system 10. Such devices include the pump 36, the light 80, any timers, and other associated equipment known to those with ordinary skill in the art. The power panel can include an electrical cord for plugging into an appropriate electrical outlet. A control panel 84 can be mounted in some appropriate location, such as on one of the soil retaining boxes. The control panel 84 generally can include a clock timer, a control for pumping, a control for lighting, and any other devices needing operator input or indication. The control panel can include a faceplate.

Some embodiments of the invention may include only one soil retaining box 14 disposed at least partially above the water retaining box 14. In other embodiments, such as shown in FIG. 1, multiple soil retaining boxes can be used. Other soil retaining boxes can be similarly constructed, as has been described above for the soil retaining box 14. In general, the second soil retaining box 18 can include a bottom and sides, a soil filter, a support, and a drain portal 88. The drain portal 88 can be conveniently disposed in the lower portions of the second soil retaining box, such as in the bottom 86 of the box.

The light 80 can be disposed below the second soil retaining box, so that the light can shine on the first soil retaining box, when the second soil retaining box is situated higher than the first soil retaining box. Similarly, a second light 92 can be disposed below the third soil retaining box 20, allowing the light 92 to shine on a growing area of the second soil retaining box 18. A water line 90 can be coupled to the water line 38 from the pump 36 to allow water to be pumped to the second soil retaining box 18.

The third soil retaining box 20 can include similar features, such as sides, bottom, soil filter, support, drain portal, water line, light, and other features as have been described above. Generally, a higher soil retaining box is aligned above a lower retaining box, so that the drain portals can drain excess water to the lower soil retaining box.

In operation, water can be placed in the water retaining box 12, such as through the water fill opening 26. In some embodiments, the water level can be automatically maintained by coupling the water retaining box to a water supply. In other embodiments, the water retaining box can be replenished with water at periodic intervals. The control panel 84 can be programmed to operate in a manual or automatic mode, for example, using the pump 36 to pump water through the various water lines, and lights to provide lighting. The water line 38 can provide water up to the water line 70 that can drain water into the first soil retaining box 14. Excess water drains through the soil filter 56, the support 58, the drain portal 62, and back into the water retaining box 12. Likewise, the light 80 can be activated at desired intervals to assist plant growth, independent of ambient lighting.

If a second soil retaining box 18 is included in the system, water from the water line 38 can also flow into the water line 90 to provide water to the second soil retaining box 18. Excess water in the second soil retaining box 18 can drain through the soil, the filter, the support, and the drain portal 88. Since the drain portal 88 of the second soil retaining box 18 is generally aligned with the first soil retaining box 14, excess water draining through the drain portal 88 can fall on the soil or plants in the first soil retaining box 14. Any excess water can thence drain through the drain portal 62 of the first soil retaining box 14 and back into the water retaining box 12, as has been described. A similar process can occur for the third soil retaining box 20.

If the water retaining box 12 is to be drained, as in relocation, cleaning, or other maintenance functions, the drain 41 can be used to drain the water out through an open valve 40. For convenience, a hose can be attached to the valve 40 to suitably dispose of the water in a selected location.

In some embodiments, the self-contained planter system 10 can include a structural bollard 94. The structural bollard is generally a structural piece of relative considerable weight and strength that adds stability to the self-contained planter system. The bollard can also provide for force protection against oncoming objects that could damage the planter system 10. A sufficiently sized bollard could provide protection from misguided objects that could injure occupants in a building. For example, an architect may choose to locate the self-contained planter system near a large window to provide some protection against someone or something trying to crash through the large window into the occupied area. The bollard 94 can be structurally embedded inside the columnar support 16 for aesthetic reasons or can be mounted to an exterior surface of the self-contained planter system.

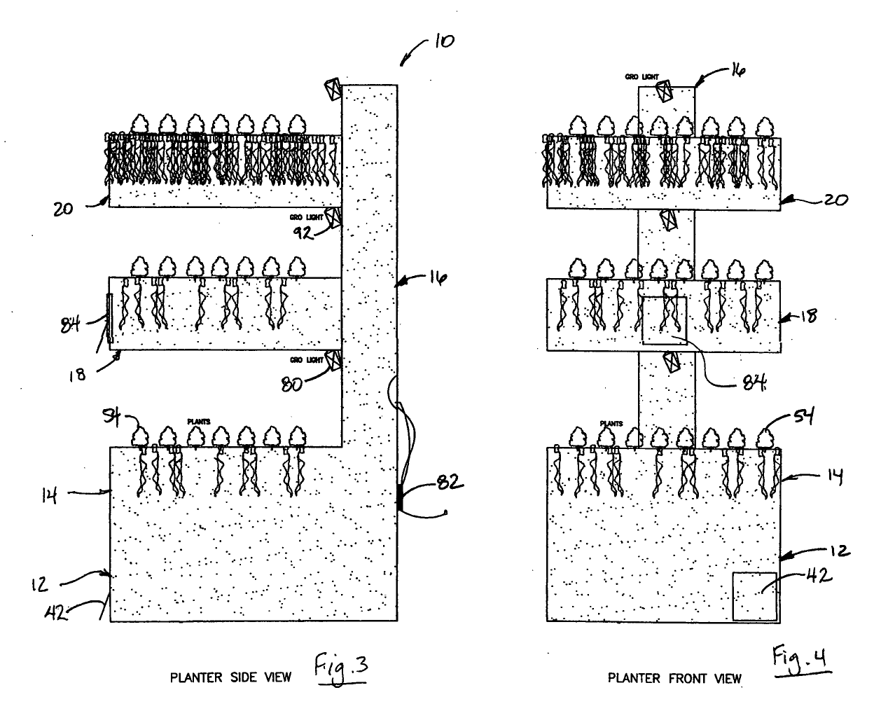

FIG. 3 is a schematic side view of the self-contained planter system of FIG. 1. FIG. 3 illustrates the general layout of the self-contained planter system from the side view as might be seen by an occupant of a building or other location where the self-contained planter system is located. Various plants 54 can be planted in the first soil retaining box 14 and other soil retaining boxes 18, 20, as appropriate. The enclosure 42 can be accessed for suitable operation, such as draining, described herein. The power panel 82 is generally mounted in some appropriate location on the self-contained planter system, such as along the columnar support 16, and having an appropriate power cord for connecting to the power outlet. The control panel 84 can be disposed at some aesthetically pleasing location that will allow an operator access. The lights 80, 92 can be disposed at an appropriate location such as below a higher soil retaining box but above a lower soil retaining box upon which the respective light is to shine.

FIG. 4 is a front schematic view of the self-contained planter system of FIG. 1. The shape of the various structural elements, such as the water retaining box, the soil retaining boxes, and the columnar support, can vary as may be appropriate for a particular architectural effect or location. Thus, the shapes shown are only exemplary. The shapes can be rectangular, square, oval, rounded or sharp-cornered, and other various shapes. Aesthetically, the water retaining box 12 and first soil retaining box 14 can be fitted into a single enclosure. The columnar support 16 can support one or more of the soil retaining boxes, such as the second and third soil retaining boxes, described herein. Further, the columnar support 16 can provide adjustable heights to which the soil retaining boxes can be situated. The enclosure 42 can be disposed at some portion of the water retaining box 12 and the control panel 84 can be disposed at some appropriate location to allow operator access.

While the foregoing is directed to various embodiments of the present invention, other and further embodiments may be devised without departing from the basic scope thereof. Other embodiments within the scope of the claims herein will be apparent to one skilled in the art from consideration of the specification and practice of the invention as disclosed herein. For example, multiple columnar supports can be used. It is intended that the specification, together with the example, be considered exemplary only, with the scope and spirit of the invention being indicated by the claims that follow.

The various methods and embodiments of the invention can be included in combination with each other to produce variations of the disclosed methods and embodiments, as would be understood by those with ordinary skill in the art, given the understanding provided herein. Also, various aspects of the embodiments could be used in conjunction with each other to accomplish the understood goals of the invention. Also, the directions such as “top,” “bottom,” “left,” “right,” “upper,” “lower,” and other directions and orientations are described herein for clarity in reference to the figures and are not to be limiting of the actual device or system or use of the device or system. Unless the context requires otherwise, the word “comprise” or variations such as “comprises” or “comprising”, should be understood to imply the inclusion of at least the stated element or step or group of elements or steps or equivalents thereof, and not the exclusion of a greater numerical quantity or any other element or step or group of elements or steps or equivalents thereof. The device or system may be used in a number of directions and orientations. Further, the order of steps can occur in a variety of sequences unless otherwise specifically limited. The various steps described herein can be combined with other steps, interlineated with the stated steps, and/or split into multiple steps. Additionally, the headings herein are for the convenience of the reader and are not intended to limit the scope of the invention.

Further, any references mentioned in the application for this patent as well as all references listed in the information disclosure originally filed with the application are hereby incorporated by reference in their entirety to the extent such may be deemed essential to support the enabling of the invention. However, to the extent statements might be considered inconsistent with the patenting of the invention, such statements are expressly not meant to be considered as made by the Applicant.

1. A self-contained planter system, comprising:
a. a water retaining box;
b. an elevated first soil retaining box disposed above at least a portion of the water retaining box and having a quantity of soil dispersed across the box; and
c. a drain portal disposed in a lower portion of the soil retaining box and above at least the portion of the water retaining box, and adapted to drain into the water retaining box.

2. The self-contained planter system of claim 1, further comprising an elevated second soil retaining box disposed above the first soil retaining box and a drain portal disposed in a lower portion of the second soil retain box, the drain portal of the second soil retaining box being disposed above the first soil retaining box and adapted to drain into the first soil retaining box.

3. The self-contained planter system of claim 1, fiber comprising a plurality of soil retaining boxes disposed above at least one other soil retaining box and a drain portal disposed in a lower portion of a plurality of the soil retaining boxes, wherein Me drain portal of a higher elevated soil retaining box relative to the at least one other soil retaining box drains excess water down to the at least one other elevated soil retaining box.

4. The self-contained planter system of claim 1, further comprising a pump coupled to the water retaining box to pump water to the elevated soil retaining box.

5. The self-contained planter system of claim 1, further comprising a light mounted above the soil retaining box to assist in growth of plants planted therein.

6. The self-contained planter system of claim 5, further comprising a plurality of elevated soil retaining boxes, wherein the light is below at least one of the elevated soil retaining boxes.

7. The self-contained planter system of claim 2, wherein at least one of the soil retaining boxes has an adjustable elevation relative to the water retaining box.

8. The self-contained planter system of claim 1, further comprising a columnar support for the elevated soil retaining box.

9. The self-contained planter system of claim 8, further comprising a structural bollard coupled to the columnar support.

10. The self-contained planter system of claim 1, further comprising a control panel coupled to the water retaining box.

11. The self-contained planter system of claim 1, further comprising an enclosure formed in the water retaining box and accessible from an exterior portion of the water retaining box, the enclosure housing a drain valve sealing coupled to a water portion of the water retain box.

12. The self-contained planter system of claim 1, further comprising plants planted in the soil retaining box.

13. A self-contained planter system, comprising:
a. a water retaining box;
b. an elevated first soil retaining box disposed at least partially above the water retaining box and having first quantity of soil dispersed across the first soil retaining box, and a drain portal disposed in a lower portion of the first soil retaining box and above the water retaining box;
c. an elevated second soil retaining box disposed at least partially above the first soil retaining box and having second quantity of soil dispersed across the second soil retaining box box, and a drain portal disposed in a lower portion of the second soil retaining box and above the first soil retaining box;
d. a water line coupled to at least the second soil retaining box;
e. a pump coupled to the water retaining box to pump water at least to the second soil retaining box through the water line; and
f. a light mounted above the first soil retaining box and below the second elevated soil retaining box.

14. The self-contained planter system of claim 13, further comprising a columnar support for the elevated soil retaining boxes.

15. The self-contained planter system of claim 14, further comprising a structural bollard coupled to the columnar support.

16. The self-contained planter system of claim 13, further comprising a control panel coupled to the water retain box.

17. The self-contained planter system of claim 13, further comprising an enclosure formed in the water retaining box and accessible from an exterior portion of the water retaining box, the enclosure housing a drain valve sealingly coupled to a water portion of the water retaining box.

18. The self-contained planter system of claim 13, wherein at least one of the soil retaining boxes has an adjustable elevation relative to the water retaining box.

19. The self-contained planter system of claim 13, wherein the second soil retaining box is adapted to allow water to drain through the drain portal onto foliage planted in the first soil retaining box.

20. A process for watering plants in a self-contained planter system, the system comprising a water retaining box; an elevated first soil retaining box disposed at least partially above the water retaining box with a first drain portal disposed in a lower portion of the first soil retaining box and above the water retaining box; and an elevated second soil retaining box disposed at least partially above the first soil retaining box with a second drain portal disposed in a lower portion of the second soil retaining box and above the first soil retaining box, the process comprising:
a. providing water to the second soil retaining box;
b. watering plants planted in soil in the second soil retaining box;
c. allowing water to drain through the second drain portal of the second soil retaining box onto at least some foliage of plants planted in soil in the first soil retaining box;
d. watering plants planted in the first soil retaining box; and
e. allowing water to drain through the first drain portal of the first soil retaining box into the water retaining box.
